(19) United States
(12) Patent Application Publication
(10) Pub. No.: US 2008/0261049 A1
(43) Pub. Date: Oct. 23, 2008

(54) Electroconductive Paste and Substrate Using the Same for Mounting Electronic Parts

(76) Inventors: Hiroki Hayashi, Ibaraki (JP); Ayako Taira, Ibaraki (JP); Satoshi Ebana, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/573,133

(22) PCT Filed: Jul. 29, 2005
(86) PCT No.: PCT/JP05/13957

§ 371 Date: Sep. 18, 2007

(30) Foreign Application Priority Data
Aug. 3, 2004 (JP) 2004-227184
Aug. 3, 2004 (JP) 2004-227195

(51) Int. Cl. B32B 15/092; H01B 1/22

(52) U.S. Cl. 428/418; 252/512

(57) ABSTRACT

The conductive paste of the invention comprises a conductive powder and a binder component, wherein the conductive powder is composed of metal powder which is copper powder or copper alloy powder partially covered on the surface with silver, and is either a mixture of roughly spherical metal powder and flat metal powder, or roughly spherical or flat metal powder alone, and wherein the binder component contains a mixture of an epoxy resin and an imidazole compound with a hydroxyl group or a mixture of an epoxy resin and an imidazole compound with a carboxyl group.

### TECHNICAL FIELD

The present invention relates to a conductive paste to be used as an electronic part, circuit wiring material, electrode material, conductive connecting material or conductive adhesive, and to an electronic part mounting board employing it.

### BACKGROUND ART

Connecting methods using lead-containing solder are widely known for mounting of electronic parts onto circuit boards and the like. With the increasing awareness of environmental problems in recent years, however, interest has become focused on lead-free solders as solders containing no lead, and conductive pastes.

Conductive pastes contain precious metals and are therefore more expensive than lead-free solder, but they also provide numerous advantages including lower mounting temperatures and more flexible joints. As described in Non-patent document 1, conventional conductive pastes have been produced by using conductive powder of gold, silver, copper, carbon or the like and then adding a binder, organic solvent and additives if necessary, and mixing these into a paste form. It has become common to use gold powder or silver powder particularly in fields that require high conductivity.

Newer conductive pastes generally use silver or copper as conductive powder from the viewpoint of cost, practicality and conductivity. Conductive pastes containing silver powder have good conductivity and are therefore used to form electrical circuits and electrodes on printed circuit boards, electronic parts and the like, but a drawback arises when an electric field is applied in an ambience of high temperature and high humidity, since silver electrocrystallization known as “migration” occurs in the electrical circuit or electrode and causes shorting between electrodes or wirings. Several strategies have been employed to prevent such migration, and measures have been studied such as coating a moisture-proof paint on the conductor surface or adding a corrosion inhibitor such as a nitrogen-containing compound to the conductive paste, but these have not provided satisfactory effects. Furthermore, the silver powder content must be increased to obtain a conductor with good conduction resistance, and because of the high cost of silver powder, the conductive pastes are also undesirably increased in cost.

Conductive pastes using silver-covered copper powder have also been proposed to improve migration and obtain cheaper conductive pastes (for example, see Patent document 5). However, when the silver is coated evenly and thickly, the improving effect on migration is not adequately exhibited. Conversely, if it is too thinly coated it becomes necessary to increase the loading weight of the conductive powder to satisfactorily ensure conductivity, and this results in a smaller amount of binder and thus reduced adhesion (adhesive strength).

Conductive pastes employing copper powder as conductive powder have also been proposed (for example, see Patent document 6). However, in the case of conductive pastes employing copper powder, because copper is easily oxidized after heat setting, oxygen in the air and binder reacts with the copper powder to form an oxide film on the surface, and thereby the conductivity is notably lowered. Copper pastes have therefore been developed having stabilized conductivity by addition of various additives to prevent oxidation of the copper powder, but the conductivity is not as high as silver pastes, and the shelf life has also been less than satisfactory.

Conductive pastes employing phenol resins for improved conductivity have also been proposed (for example, see Patent document 7). Although such conductive pastes exhibit higher conductivity than conductive pastes employing epoxy resins, the by-products generated during polymerization of the phenol resins produce voids, and the adhesive strength therefore tends to be lower. On the other hand, conductive pastes employing epoxy resins have higher adhesive strength than conductive pastes employing phenol resins but tend to have poorer conductivity, and therefore the amount of packed conductive powder must be increased to ensure adequate conductivity. In other words, no conductive paste can be found among the currently used conductive pastes which exhibits excellent conductivity, adhesive strength, workability and migration resistance, while being comparative to lead solder in terms of cost.

The following measures have been devised for preventing migration. In Patent document 1 and Patent document 2 there are disclosed conductive pastes with addition of migration inhibitors or pretreatment of the conductive particles. Examples of silver-covered copper powder are found in Patent document 3 and Patent document 4.

Patent document 1: Japanese Unexamined Patent Publication No. 2001-189107

Patent document 2: Japanese Unexamined Patent Publication No. 2002-161259

Patent document 3: Japanese Examined Patent Publication HEI No. 6-72242

Patent document 4: Japanese Unexamined Patent Publication HEI No. 10-134636

Patent document 5: Japanese Unexamined Patent Publication HEI No. 7-138549

Patent document 6: Japanese Unexamined Patent Publication HEI No. 5-212579

Patent document 7: Japanese Unexamined Patent Publication HEI No. 6-157946

Non-patent document 1: Denshi Zairyo, October 1994, pp. 42-46

### DISCLOSURE OF THE INVENTION

### Problems To Be Solved By the Invention

It is an object of the present invention, which has been accomplished in light of the aforementioned problems of the prior art, to provide a conductive paste with excellent conductivity, adhesive strength and migration resistance. It is another object of the invention to provide an electronic part mounting board with satisfactory conductivity.

The invention as described in claims 1 to 14 provides a conductive paste with excellent conductivity, adhesive strength and migration resistance.

The invention as described in claim 15 provides an electronic part mounting board with satisfactory conductivity.

### Means For Solving the Problems

As a result of much diligent research directed toward achieving the object stated above, the present inventors have discovered that by using a prescribed conductive powder together with a combination of an epoxy resin and an imidazole compound having a specified structure as the binder component, it is possible to obtain a conductive paste exhibiting both conductivity and adhesive strength while having excellent migration resistance, and the present invention has thereupon been completed.

Specifically, the invention provides a conductive paste comprising conductive powder and a binder component, wherein the conductive powder is composed of metal powder which is copper or copper alloy powder partially covered on the surface with silver, and is either a mixture consisting of roughly spherical metal powder and flat metal powder, or a simple powder consisting of roughly spherical or flat metal powder alone, and the binder component contains a mixture of an epoxy resin and an imidazole compound with a hydroxyl group.

Alternatively, the invention provides a conductive paste comprising conductive powder and a binder component, wherein the conductive powder is composed of metal powder which is copper or copper alloy powder partially covered on the surface with silver, and is either a mixture of roughly spherical metal powder and flat metal powder, or roughly spherical or flat metal powder alone, and the binder component contains a mixture of an epoxy resin and an imidazole compound with a carboxyl group.

According to the invention there is provided conductive paste exhibiting excellence in all the properties of conductivity, adhesive strength and migration resistance.

The mixing ratio of the conductive powder and binder component in the aforementioned conductive paste (conductive powder:binder component) is preferably 20:80 to 60:40 in terms of volume ratio.

The mixing proportion of the imidazole compound in the conductive paste is preferably 2 to 18 wt % based on the total binder component.

The imidazole compound with a hydroxyl group in the conductive paste is preferably 2-phenyl-4,5-dihydroxymethylimidazole or 2-phenyl-4-methyl-5-hydroxymethylimidazole.

The imidazole compound with a carboxyl group in the conductive paste is preferably 1-cyanoethyl-2-phenylimidazolium trimellitate, 1-cyanoethyl-2-undecylimidazolium trimellitate, 1-cyanoethyl-2-methylimidazolium trimellitate, 1-cyanoethyl-2-ethyl-4-methylimidazolium trimellitate or 1-benzyl-2-phenylimidazolium trimellitate.

The invention still further provides an electronic part mounting board comprising a board and electronic part connected by a conductive member, wherein the conductive member is obtained by curing the conductive paste of the invention by a thermosetting process in which the temperature-elevating rate is 2 to 20° C./min until reaching the maximum temperature and the oxygen concentration is 20 to 50000 ppm.

This can yield an electronic part mounting board with satisfactory conductivity.

### Effect of the Invention

According to the invention there is provided a conductive paste that maintains a prescribed adhesive strength while exhibiting excellent conductivity and migration resistance. Moreover, by using a conductive paste of the invention it is possible to provide an electronic part mounting board with satisfactory conductivity.

### BRIEF DESCRIPTION OF THE DRAWINGS

FIG. 1 is a schematic cross-sectional view showing a preferred embodiment of an electronic part mounting board of the invention.

FIG. 2 is a schematic cross-sectional view showing another preferred embodiment of an electronic part mounting board of the invention.

FIG. 3 is a schematic cross-sectional view showing another preferred embodiment of an electronic part mounting board of the invention.

FIG. 4 is a schematic cross-sectional view showing another preferred embodiment of an electronic part mounting board of the invention.

FIG. 5 is a graph showing an example of a thermosetting process for heat curing of a conductive paste according to the invention.

FIG. 6 is a schematic plan view showing electrodes for evaluation of migration resistance.

FIG. 7 is a schematic cross-sectional view showing electrodes for evaluation of migration resistance.

FIG. 8 is a diagram of an electrical circuit for evaluation of migration resistance.

1,2,3,4: Electronic part mounting board, 10: conductive member, 12,24: board, 14: board connecting terminal, 16: electronic part, 18: electronic part connecting terminal, 20: lead, 22: solder ball.

### BEST MODES FOR CARRYING OUT THE INVENTION

Preferred embodiments of the invention will now be explained in detail, with reference to the accompanying drawings as necessary. Throughout the explanation which follows, identical or corresponding parts will be referred to by like reference numerals and overlapping explanation will be omitted.

Since the conductive paste of the invention has about the same conductivity as solder, and excellent adhesive strength (anchoring force), it has a wide range of uses as a substitute material for sections in which solder has conventionally been used. It may also, of course, be used in fields that do not require strong adhesive properties. That is, it may be used for bonding between passive components and electronic parts such as LSI packages, and boards including: plastic films of polyimide resins or epoxy resins; glass nonwoven fabrics and the like impregnated and set with plastics such as polyimide resins, epoxy resins and BT resins; and ceramics boards such as alumina.

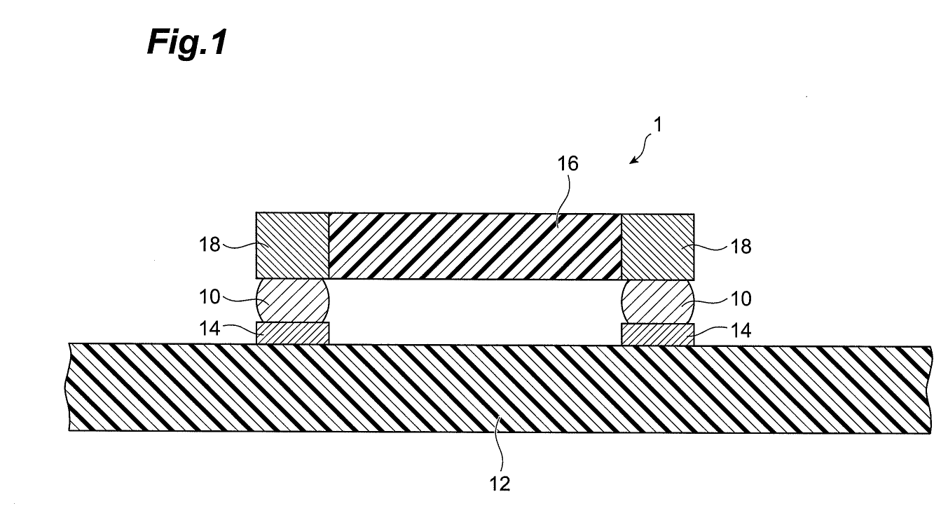

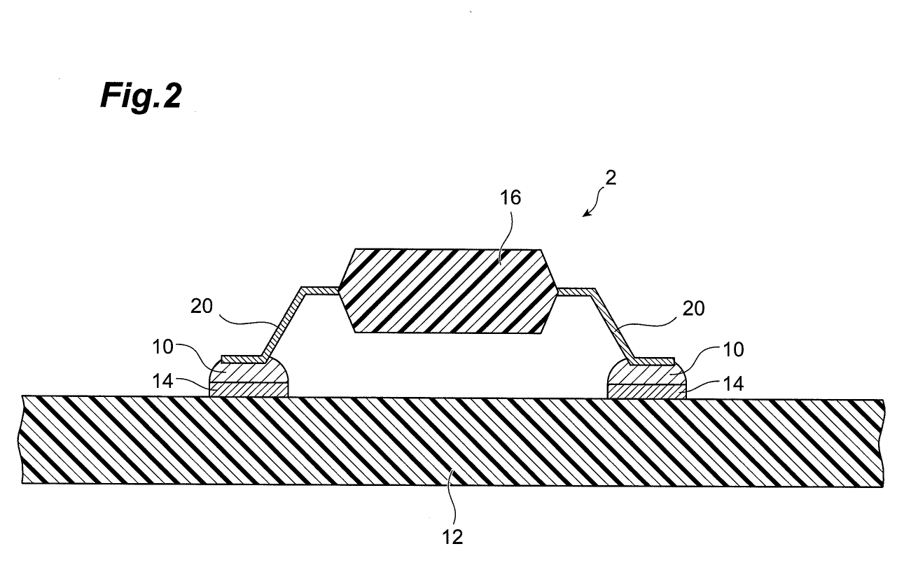

Specifically, the conductive paste of the invention may be applied as illustrated in FIGS. 1 and 2, for connection of passive components that have been conventionally connected with solder, or for connection of electronic parts such as semiconductor elements that have been connected with solder or anisotropic conductive films. In particular, since the conductive paste of the invention allows connection at lower temperature than solder it can be applied for connection of parts with poor heat resistance, such as CCD modules. Also, connection between semiconductor elements and boards using solder has required injection of an underfill material between the element and board in order to alleviate stress created by the difference in thermal expansion coefficients of the semiconductor element and board. With connection using the conductive paste of the invention, however, the resin component has a stress relaxation effect so that no underfill material is required and the process can therefore be simplified.

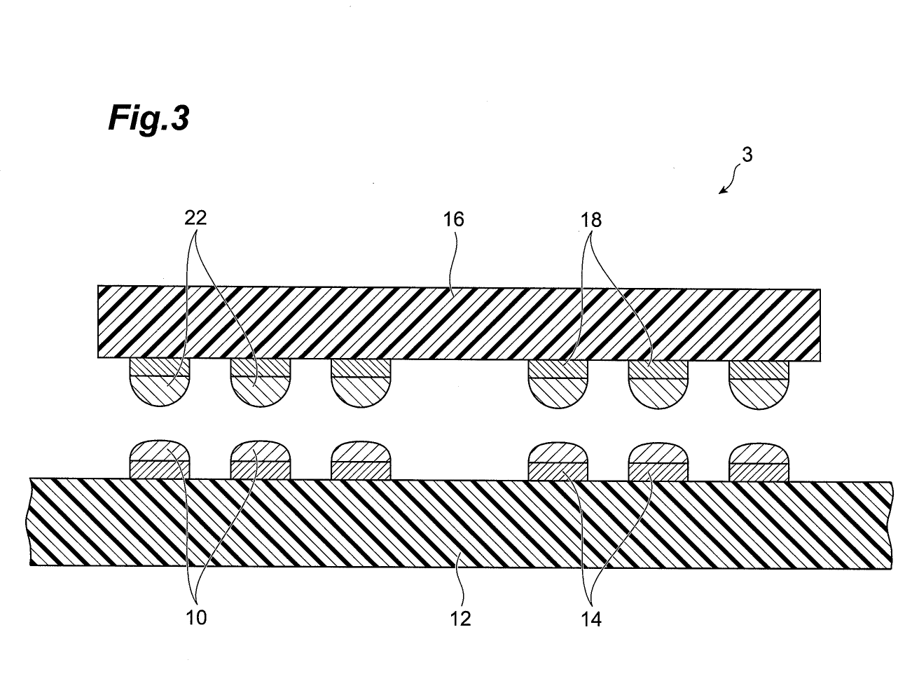

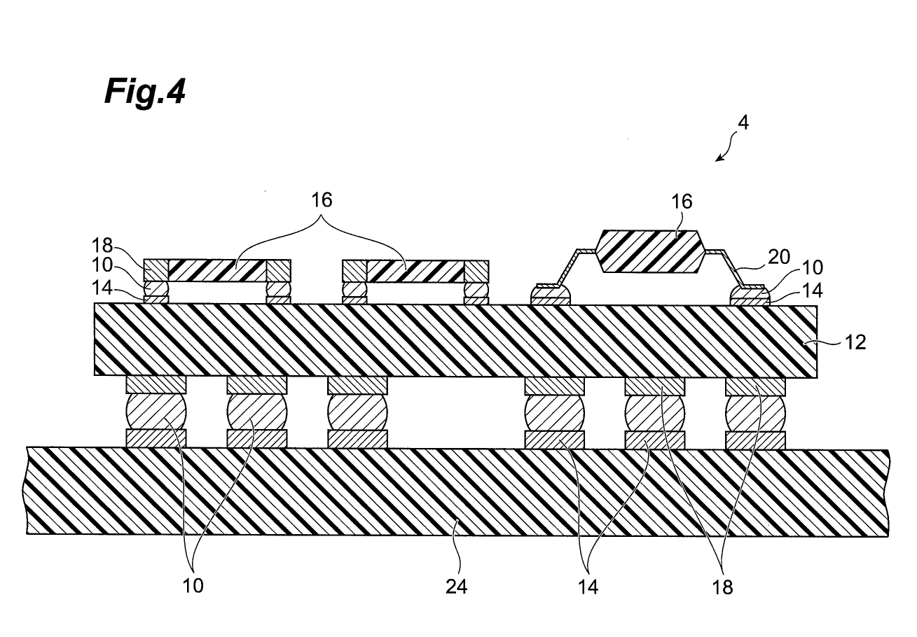

Moreover, as shown in FIG. 3, the conductive paste of the invention can be used in combination with solder for connection between semiconductor elements and boards. In addition, as shown in FIG. 4, the conductive paste of the invention can be used for mounting of passive component-mounted boards as interposers onto separate boards such as motherboards.

The conductive paste of the invention used for this purpose comprises (A) a conductive powder and (B) a binder component, wherein the (B) binder component contains a mixture of (b1) an epoxy resin and (b2) an imidazole compound with a hydroxyl group or carboxyl group. Each of the components will now be described in detail.

### (A) Conductive Powder

The (A) conductive powder used for the invention is composed of metal powder (silver-covered copper powder or silver-covered copper alloy powder) in which the surface of copper powder or copper alloy powder is generally coated with silver while portions of the surface is exposed. In other words, it consists of metal powder wherein the surface of the copper powder or copper alloy powder is partially covered with silver. If the (A) conductive powder is totally covered with silver, without portions of the copper powder or copper alloy powder being exposed, the migration property will tend to be inferior. If the exposed area of the surface of the copper powder or copper alloy powder is too large, conductivity will tend to be reduced due to oxidation of the copper powder. Thus, the exposed area of the surface of the copper powder or copper alloy powder is preferably in the range of 1 to 70%, more preferably in the range of 10 to 60% and even more preferably in the range of 10 to 55% from the standpoint of migration properties, oxidation of exposed sections and conductivity.

The copper powder or copper alloy powder used is preferably powder prepared by an atomizing method, and a smaller grain size is preferred to increase probability of contact with the (A) conductive powder and achieve high conductivity. For example, the mean particle size of the powder used is preferably in the range of 1 to 20 μm and more preferably in the range of 1 to 10 μm.

The method of covering the surface of the copper powder or copper alloy powder with silver may be displacement plating, electroplating, electroless plating or the like. Covering by displacement plating is preferred for high adhesion between the copper powder or copper alloy powder and silver and reduced running cost.

If the degree of coverage of silver on the surface of the copper powder or copper alloy powder is too large the cost will be increased and the migration resistance will be reduced, while if it is too little the conductivity will tend to be reduced. The silver coverage is therefore preferably in the range of 5 to 25 wt % and more preferably in the range of 10 to 23 wt % with respect to the copper powder or copper alloy powder (in terms of silver weight based on the total weight of the copper powder or copper alloy powder and silver).

The (A) conductive powder used for the invention is composed of a mixed powder consisting of roughly spherical metal powder and flat metal powder, or a simple powder consisting of spherical or flat metal powder alone. Here, “roughly spherical metal powder” includes the concept of “spherical metal powder”. Such metal powders may be used in different combinations and proportions depending on the conductive paste viscosity, the coating area, the film thickness, the bonding specifications of the joint and the required properties.

For example, in order to achieve satisfactory conductivity in the direction of the plane, it is preferred to use flat metal powder as the (A) conductive powder from the viewpoint of contact area between the conductive powder, orientation, etc. On the other hand, in order to achieve satisfactory conductivity in the cross-sectional direction, it is preferred to use roughly spherical metal powder as the (A) conductive powder because it will increase the volume occupied by single particles in the cross-sectional direction.

In the case of a conductive paste smoothly coated on a base material, the adhesive strength when using flat metal powder as the (A) conductive powder will tend to exhibit a higher value than using roughly spherical metal powder, although the adhesive strength will also differ depending on the joint specifications.

For example, when the conductive paste is used to bond a lead frame to a copper foil, from the viewpoint of conductivity, adhesive strength, workability and reliability the (A) conductive powder is preferably a mixed metal powder wherein the proportion of roughly spherical metal powder and flat metal powder (spherical metal powder:flat metal powder) is in the range of 40:60 to 98:2 by weight. Using such a mixed metal powder will give more satisfactory results.

When primarily flat metal powder is used as the (A) conductive powder the viscosity of the conductive paste will be increased, whereas when primarily roughly spherical metal powder is used, the viscosity will be reduced and the workability improved compared to using primarily flat metal powder.

In order to achieve equivalent conductive paste viscosity when using primarily roughly spherical metal powder and using primarily flat metal powder as the (A) conductive powder, the proportion when using roughly spherical metal powder may be increased above the proportion when using the flat metal powder. That is, to produce conductive paste with a prescribed viscosity when using primarily roughly spherical metal powder as the (A) conductive powder, the proportion of the (A) conductive powder in the conductive paste may be higher than when using primarily flat metal powder.

Roughly spherical metal powder used as the (A) conductive powder preferably has a long-axis mean particle size of 1 to 20 μm, an aspect ratio of 1 to 1.5, a tap density of 4.5 to 6.2 g/cm³, a relative density of 50 to 68% and an area-to-weight ratio of 0.1 to 1.0 m²/g. On the other hand, flat metal powder preferably has a long-axis mean particle size of 5 to 30 μm, an aspect ratio of 3 to 20, a tap density of 2.5 to 5.8 g/cm³, a relative density of 27 to 63% and an area-to-weight ratio of 0.4 to 1.3 m²/g.

If the respective upper limits of the mean particle size ranges for roughly spherical metal powder and flat metal powder are exceeded, the probability of contact of the (A) conductive powder will be lower and the conductivity will tend to be reduced. On the other hand, if the mean particle sizes are below the lower limits of the aforementioned ranges, the viscosity will increase and the adhesive strength will tend to be reduced. Likewise if the aspect ratio is above the upper limit of the aforementioned range, the viscosity will be increased and the adhesive strength will tend to be reduced. On the other hand, if the aspect ratio is below the lower limit of the aforementioned range, the conductivity will tend to be reduced. If the area-to-weight ratio is above the upper limit of the aforementioned range, the adhesive strength will tend to be reduced. On the other hand, if the area-to-weight ratio is below the lower limit of the aforementioned range, the conductivity will tend to be reduced. If the tap density is above the upper limit of the aforementioned range, the conductivity will tend to be reduced. On the other hand, if the tap density is below the lower limit of the aforementioned range, the viscosity will increase and the adhesive strength will tend to be reduced.

According to the invention, the aspect ratio of the metal powder is the ratio of the long-axis (μm) and short-axis (μm) (long-axis/short-axis) of the metal powder grains. The aspect ratio may be measured by the following procedure. First, the metal powder grains are placed in a low-viscosity curing resin and mixed, and the mixture is allowed to stand for settling of the grains and hardening of the resin to produce a cured product. The cured mixture is then cut in the vertical direction and the shapes of the grains appearing in the cross-section surface are observed under magnification with an electron microscope. The long-axis/short-axis ratio for each of at least 100 grains is determined, and the average is calculated as the aspect ratio.

The short-axis for a grain appearing in the cross-section surface is the shortest distance between two parallel lines that are tangential to the outside of the grain and sandwiching the grain. On the other hand, the long-axis is the distance between two parallel lines that are at right angles to the parallel lines used to determine the short-axis, with the parallel lines being drawn tangential to the outside of the grain at the maximum distance. The rectangle defined by the four lines is the size in which the grain exactly fits.

### (B) Binder Component

The major components of the (B) binder component according to the invention are (b1) an epoxy resin and (b2) an imidazole compound with a hydroxyl group or carboxyl group. The mixing ratio of the (A) conductive powder and (B) binder component is preferably (A) conductive powder:(B) binder component=20:80 to 60:40 based on the solid portion of the conductive paste. From the viewpoint of adhesion, conductivity and workability, the (A) conductive powder:(B) binder component ratio is more preferably 30:70 to 50:50. If the volume ratio of the (A) conductive powder in the proportion of mixing is less than 20 vol % based on the total volume of the (A) conductive powder and (B) binder component, the conductivity will tend to be impaired, while if it is greater than 60 vol % the binder component will be reduced and the adhesive force will tend to be lower. According to the invention, the (B) binder component is a mixture comprising the aforementioned (b1) epoxy resin and (b2) imidazole compound, as well as a (b3) curing accelerator added as necessary and a (b4) curing agent added as necessary. The constituent materials of the (B) binder component will now be explained in order.

### (b1) Epoxy Resin

The (b1) epoxy resin is preferably a compound with at least two epoxy groups in the molecule, and for example, there may be mentioned epoxy resins derived from bisphenol A, bisphenol F, bisphenol AD and the like and epichlorhydrin.

As examples of such compounds there may be mentioned the bisphenol A-type epoxy resins AER-X8501 (trade name of Asahi Kasei Corp.), R-301 (trade name of Yuka-Shell Epoxy Co. Ltd.) and YL-980 (trade name of Yuka-Shell Epoxy Co. Ltd.), the bisphenol F-type epoxy resin YDF-170 (trade name of Tohto Kasei Co., Ltd.), the bisphenol AD-type epoxy resin R-1710 (trade name of Mitsui Petroleum Chemical Co., Ltd.), the phenol-novolac-type epoxy resins N-730S (trade name of Dainippon Ink and Chemicals, Inc.) and Quatrex-2010 (trade name of Dow Chemical Corp.), the cresol-novolac-type epoxy resins YDCN-702S (trade name of Tohto Kasei Co., Ltd.) and EOCN-100 (trade name of Nippon Kayaku Co., Ltd.), the polyfunctional epoxy resins EPPN-501 (trade name of Nippon Kayaku Co., Ltd.), TACTIX-742 (trade name of Dow Chemical Corp.), VG-3010 (trade name of Mitsui Chemicals, Inc.) and 1032S (trade name of Yuka-Shell Epoxy Co. Ltd. epoxy), the naphthalene skeleton-containing epoxy resin HP-4032 (trade name of Dainippon Ink and Chemicals, Inc.), the alicyclic epoxy resins EHPE-3150, CEL-3000 (both trade names of Daicel Chemical Industries, Ltd.), DME-100 (trade name of New Japan Chemical Co., Ltd.) and EX-216L (trade name of Nagase Chemicals, Ltd.), the aliphatic epoxy resin W-100 (trade name of New Japan Chemical Co., Ltd.), the amine-type epoxy resins ELM-100 (trade name of Sumitomo Chemical Co., Ltd.), YH-434L (trade name of Tohto Kasei Co., Ltd.), TETRAD-X and TETRAC-C (both trade names of Mitsubishi Gas & Chemical Co., Inc.), the resorcin-type epoxy resin DENACOL EX-201 (trade name of Nagase Chemicals, Ltd.), the neopentylglycol-type epoxy resin DENACOL EX-211 (trade name of Nagase Chemicals, Ltd.), the hexanediol glycol-type epoxy resin DENACOL EX-212 (trade name of Nagase Chemicals, Ltd.), ethylene/propylene glycol-type epoxy resins of the DENACOL EX Series (EX-810, 811, 850, 851, 821, 830, 832, 841, 861 (all trade names of Nagase Chemicals, Ltd.), the epoxy resins E-XL-24 and E-XL-3L represented by following general formula (I) (both trade names of Mitsui Chemicals, Inc.), and the like. These epoxy resins may be used alone or in combinations of two or more.

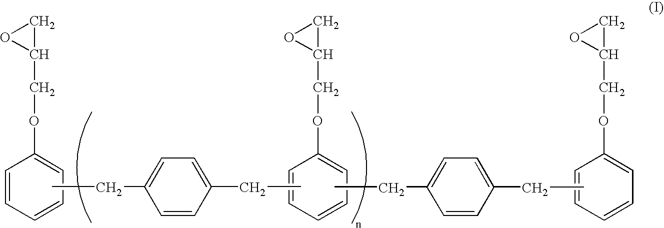

(wherein n represents an integer of 1 to 5)

The epoxy resin may also include an epoxy compound having only one epoxy group in the molecule (reactive diluent). Such an epoxy compound may be used in a range that does not inhibit the properties of the conductive paste of the invention, and preferably in a range of 0 to 30 wt % with respect to the total epoxy resin. As commercially available epoxy compounds of this type there may be mentioned PGE (trade name of Nippon Kayaku Co., Ltd.), PP-101 (trade name of Tohto Kasei Co., Ltd.), ED-502, ED-509 and ED-509S (trade names of Adeka Corp.), YED-122 (trade name of Yuka-Shell Epoxy Co. Ltd.), KBM-403 (trade name of Shin-Etsu Chemical Co., Ltd.), TSL-8350, TSL-8355 and TSL-9905 (trade names of Toshiba Corp.), and the like.

### (b2) Imidazole Compound

The (b2) imidazole compound used for the invention has a hydroxyl group or carboxyl group as a substituent. By using such a (b2) imidazole compound in combination with the aforementioned (b1) epoxy resin, it is possible to obtain a conductive paste with excellence in both properties of the adhesion and conductivity. As specific examples for the (b2) imidazole compound with a hydroxyl group, which is not particularly restricted so long as it has a hydroxyl group, there may be mentioned 2-phenyl-4-methyl-5-hydroxymethylimidazole (2P4MHZ, Shikoku Chemicals Corp.) and 2-phenyl-4,5-hydroxymethylimidazole (2PHZ, Shikoku Chemicals Corp.). These may be used alone or in combinations of two or more. As specific examples for the (b2) imidazole compound with a carboxyl group, which is not particularly restricted so long as it has a carboxyl group, there may be mentioned 1-cyanoethyl-2-phenylimidazolium trimellitate (2PZ-CNS, Shikoku Chemicals Corp.), 1-cyanoethyl-2-undecylimidazolium trimellitate (C11Z-CNS, Shikoku Chemicals Corp.), 1-cyanoethyl-2-methylimidazolium trimellitate (2MZ-CNS, Shikoku Chemicals Corp.), 1-cyanoethyl-2-ethyl-4-methylimidazolium trimellitate (2E4MZ-CNS, Shikoku Chemicals Corp.) and 1-benzyl-2-phenylimidazolium trimellitate (1B2PZ-S, Shikoku Chemicals Corp.). These may be used alone or in combinations of two or more.

The mixing proportion of the (b2) imidazole compound is preferably 2 to 18 wt % based on the total (B) binder component of the conductive paste. If the mixing proportion of the (b2) imidazole is less than 2 wt %, sufficient hardness will not be obtained and the adhesive force will tend to be reduced, while if it is greater than 18 wt % the workability will tend to be poor due to increased viscosity, or the conductivity will tend to be impaired by the unreacted (b2) imidazole compound.

### (b3) Curing Accelerator

The (b2) imidazole compound acts as a curing accelerator of an epoxy resin, but another (b3) curing accelerator may also be used in combination therewith. As examples there may be mentioned the imidazoles CUREZOL, 2-undecylimidazole (C17Z, Shikoku Chemicals Corp.), 2-phenylimidazole isocyanurate addition product (2PZ-OK, Shikoku Chemicals Corp.), 2,4-diamino-6-(2′-methylimidazolyl-(1′))-ethyl-s-triazine (2MZ-A), 1-benzyl-2-phenylimidazole (1B2PZ, both trade names of Shikoku Chemicals Corp.), the organic boron salt compounds EMZ/K and TPPK (both trade names of Hokko Chemical Industry Co., Ltd.), the tertiary amines or salts DBU, U-CAT102, 106, 830, 840, 5002 (all trade names of San-Apro Ltd.), dicyandiamide, dibasic acid dihydrazides represented by the following general formula (IV) such as ADH, PDH and SDH (all trade names of Japan Hydrazine Co., Inc.) and the microcapsular curing agent NOVACURE (Asahi Kasei Corp.) comprising an epoxy resin and amine compound reaction product.

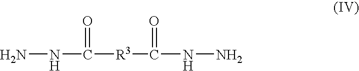

(wherein R³ represents a divalent aromatic group such as m-phenylene or p-phenylene, or a C1 to C12 linear or branched alkylene group)

### (b4) Curing Agent

A (b4) curing agent may also be used in combination. A wide range of curing agents may be used including those mentioned in the review Epoxy Resins (The Japan Society of Epoxy Resin Technology), pp. 117-209. As specific examples there may be mentioned the phenol-novolac resins H-1 (Meiwa Plastic Industries, Ltd.), VR-9300 (Mitsui Toatsu Chemicals, Inc.), the phenolaralkyl resin XL-225 (Mitsui Toatsu Chemicals, Inc.), the p-cresol-novolac resin MTPC (Honshu Chemical Industry Co., Ltd.) or the allylated phenol-novolac resin AL-VR-9300 (Mitsui Toatshu Chemicals, Inc.) represented by the following general formula (II), and the special phenol resin PP-700-300 (Nippon Petrochemicals Co., Ltd.) represented by the following general formula (III). These may be used alone or in combinations of two or more.

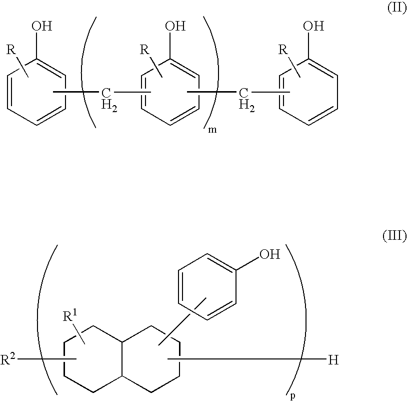

(In formulas (II) and (III), R represents a hydrocarbon group such as methyl or allyl, m represents an integer of 1 to 5, R¹ represents an alkyl group such as methyl or ethyl, R² represents hydrogen or a hydrocarbon group, and p represents an integer of 2 to 4.)

The amount of the (b4) curing agent used is preferably an amount for 0.3 to 1.2 equivalents, more preferably an amount for 0.4 to 1.0 equivalents and most preferably an amount for 0.5 to 1.0 equivalents as the total amount of reactive groups in the (b4) curing agent with respect to 1 equivalent of epoxy groups in the (b1) epoxy resin. If the total amount of reactive groups is less than 0.3 equivalent the adhesive force will tend to be reduced, and if it exceeds 1.2 equivalents the paste viscosity will tend to be increased, thereby lowering the workability. The reactive groups are substituents that are reactive with the epoxy resin, and as examples there may be mentioned phenolic hydroxyl groups.

### (C) Additives

The conductive paste of the invention may, if necessary, contain (C) additives such as plasticizers, coupling agents, surfactants, antifoaming agents, ductility enhancers, ion trapping agents and the like as appropriate. The (C) additives will be explained below.

The conductive paste of the invention may employ a plasticizer for the purpose of stress relaxation. As examples of plasticizers there may be mentioned liquid polybutadiene (CTBN-1300×31 or CTBN-1300×9 by Ube Industries, Ltd.; NISSO-PB-C-2000 by Nippon Soda Co., Ltd.) and the like. A plasticizer has the effect of relaxing stress produced by bonding between the passive components and electrodes on the board. In most cases, the plasticizer is preferably added at 0 to 500 parts by weight, where 100 parts by weight is the total of the organic polymer compound (epoxy resin, etc.) and its precursor.

The conductive paste of the invention may also employ a silane coupling agent (KBM-573 by Shin-Etsu Chemical Co., Ltd. and the like) or a titanium coupling agent, for the purpose of enhancing the adhesive strength. For improved wettability, an anionic surfactant or fluorine-based surfactant may also be used. A silicone oil or the like may also be used as an antifoaming agent. In addition, an adhesive strength enhancer, wettability improver and antifoaming agent may each be used alone or in combinations of two or more, and the amounts used are preferably 0 to 10 parts by weight with respect to 100 parts by weight of the (A) conductive powder.

Depending on the purpose, the (b1) epoxy resin may be used as a solution in the aforementioned reactive diluent. A diluent may also be added to the conductive paste of the invention if necessary to further improve the workability for forming the paste composition and the coatability during use. Preferred diluents are organic solvents with relatively high boiling points, such as butylcellosolve, carbitol, butylcellosolve acetate, carbitol acetate, dipropyleneglycol monomethyl ether, ethyleneglycol diethyl ether, α-terpineol and the like. The amounts used are preferably in the range of 0 to 30 wt % based on the total weight of the conductive paste.

The conductive paste of the invention may also contain, if necessary, appropriately added ductility enhancers such as urethane acrylate, humectants such as calcium oxide and magnesium oxide, adhesive strength enhancers such as acid anhydrides, wettability improvers such as nonionic surfactants and fluorine-based surfactants, antifoaming agents such as silicone oil, and ion trapping agents such as inorganic ion exchangers.

The conductive paste of the invention may be obtained by combining the (A) conductive powder, (B) binder component ((b1) epoxy resin, (b2) imidazole compound, a (b3) curing accelerator added as necessary and a (b4) curing agent added as necessary), and (C) additives such as a diluent added as necessary, either all at once or in portions, using an appropriate combination of dispersing/dissolving equipment such as a stirrer, kneader, triple roll, planetary mixer and the like, with heating, mixing, dissolution, decoagulation kneading or dispersion as necessary, to form a uniform paste.

An electronic part mounting board of the invention will now be explained with reference to FIGS. 1 to 4.

FIG. 1 is a schematic cross-sectional view showing a preferred embodiment of an electronic part mounting board of the invention. As shown in FIG. 1, the electronic part mounting board 1 has a construction wherein a board connecting terminal 14 formed on a board 12 and an electronic part connecting terminal 18 connected to an electronic part 16 are electrically connected by a conductive member 10. The conductive member 10 is the product of curing a conductive paste according to the invention as described above.

In order to use the conductive paste of the invention for bonding of the electronic part 16 and board 12, first the conductive paste is applied onto the board connecting terminal 14 of the board 12 by a dispensing method, screen printing method, stamping method or the like. Next, the electronic part 16 having the electronic part connecting terminal 18 is contact bonded with the board 12 on which the electronic part connecting terminal 18 and board connecting terminal 14 are electrically connected via the conductive paste, and a heating apparatus such as an oven or reflow furnace is used for heat curing of the conductive paste. This accomplishes bonding between the electronic part 16 and board 12.

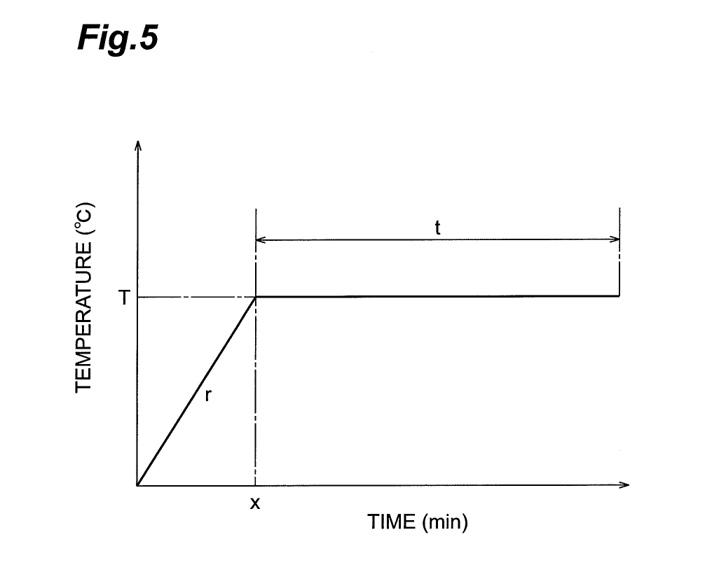

FIG. 5 is a graph showing an example of a thermosetting process for heat curing of a conductive paste. Here, the heating temperature T is preferably 100 to 300° C., and the heating time t is preferably 100 to 5000 seconds. In order to use the conductive paste to form the electronic part mounting board 1, the temperature-elevating rate r for reaching the heating temperature T (represented by r=T/x, where x is the temperature-elevating time required to reach the heating temperature T) must be 2 to 20° C./min and the oxygen concentration must be 20 to 50000 ppm. This thermosetting process can yield an electronic part mounting board 1 having a construction with the board 12 and electronic part 16 connected by the conductive member 10. Since the electronic part mounting board 1 is formed by employing a conductive paste of the invention and curing the conductive paste by the aforementioned thermosetting process, it can exhibit satisfactory conductivity.

If the temperature-elevating rate r is less than 2° C./min in the thermosetting process described above, the time of the thermosetting process will be lengthened, preventing its application for production of the electronic part mounting board 1. On the other hand, if it is greater than 20° C./min, volatile components will tend to be generated from the (B) binder component in the conductive paste, forming voids and reducing the adhesive force. The temperature-elevating rate r does not necessarily need to be a fixed temperature-elevating rate, and it may vary appropriately within the aforementioned range. As regards the oxygen concentration, an oxygen concentration of less than 20 ppm requires a long time using conventional heating equipment and is not practical, while an oxygen concentration of greater than 50000 ppm will tend to reduce the conductivity due to oxidation of the (A) conductive powder.

The electronic part mounting board of the invention is not limited to the structure shown in FIG. 1, and may instead have a structure such as shown in FIGS. 2 to 4, for example. The electronic part mounting board 2 shown in FIG. 2 has a structure wherein a board connecting terminal 14 formed on a board 12 is electrically connected with a lead 20 connected to an electronic part, by a conductive member 10 obtained by curing a conductive paste of the invention.

The electronic part mounting board 3 shown in FIG. 3 has a structure wherein a board 12 and electronic part 16 are connected by combining the conductive paste of the invention with solder. In this electronic part mounting board 3, an electronic part connecting terminal 18 is formed on the electronic part 16, and a solder ball 22 is formed on the electronic part connecting terminal 18. The solder ball 22 and the board connecting terminal 14 formed on the board 12 are electrically connected by the conductive member 10 obtained by curing the conductive paste of the invention, to form the electronic part mounting board 3.

The electronic part mounting board 4 shown in FIG. 4 has a structure wherein a board 12 mounting an electronic part 16 as shown in FIGS. 2 and 3 is further mounted on another board 24. Here as well, connection between the electronic part 16 and board 12 and connection between the board 12 and board 24 are accomplished by a conductive member 10 obtained by curing a conductive paste of the invention.

### EXAMPLES

The present invention will now be explained in greater detail by examples, with the understanding that the invention is not limited to the examples.

The materials used in the examples, comparative examples and reference examples were either fabricated by the methods described below, or were procured. Example 1 is an example of a fabrication method, and the resin compositions and mixing ratios for the other examples, comparative examples and reference examples are listed in Tables 1 to 5, although the fabrication method is the same as in Example 1.

### Example 1

After mixing 70 parts by weight of YDF-170 (trade name for bisphenol F-type epoxy resin by Tohto Kasei Co., Ltd., epoxy equivalents=170), 20 parts by weight of PP-101 (trade name for alkylphenyl glycidyl ether by Tohto Kasei Co., Ltd., epoxy equivalents=230) and 10 parts by weight of 2P4MHZ (trade name for imidazole compound with a hydroxyl group by Shikoku Chemicals Corp.), the mixture was passed through a triple roll three times to prepare a binder component.

Next, spherical copper powder with a mean particle size of 5.1 μm prepared by an atomizing method (trade name: SFR-Cu by Nippon Atomized Metal Powders Corp.) was washed with dilute hydrochloric acid and purified water, and then the spherical copper powder was subjected to displacement plating with a plating solution containing 80 g of AgCN and 75 g of NaCN per liter of water to a silver coverage of 18 wt % (silver weight=18 wt % based on the total of the spherical copper powder and silver), and finally washed and dried to obtain silver-plated copper powder.

Next, 750 g of the obtained silver-plated copper powder and 3 kg of zirconia balls with a diameter of 5 mm were loaded into a 2-liter ball mill vessel and rotated for 40 minutes, to obtain conductive powder A consisting of roughly spherical silver-covered copper powder (metal powder) with parts of the spherical copper powder covered with silver (the surface of the spherical cupper powder is partly exposed), and having a tap density of 5.93 g/cm³ (1000 taps), a relative density of 93%, an area-to-weight ratio of 0.26 m²/g, an average aspect ratio of 1.3 and a long-axis mean particle size of 5.5 μm. The proportion of the exposed area of the surface of the spherical copper powder was measured by scanning Auger electron spectroscopy, and found to be 20% of the total area of the silver-covered copper powder surface.

Next, 330 parts by weight of the roughly spherical silver-covered copper powder (conductive powder A) (volume ratio of conductive powder A=30 vol % based on total volume of conductive powder A and binder component) was added with respect to 100 parts by weight of the obtained binder component, and the components were mixed and passed through a triple roll three times, after which a vacuum stirring kneader was used for defoaming treatment at ≦500 Pa for 10 minutes to obtain a conductive paste.

### Examples 2 To 16, Comparative Examples 1 To 5 And Reference Examples 1 To 8

Conductive pastes were obtained for Examples 2 to 16, Comparative Examples 1 to 5 and Reference Examples 1 to 8 in the same manner as Example 1, except that the compositions were as listed in Tables 1 to 5, as mentioned above. The materials described in Tables 1 to 5 are explained in detail below. The units for the content of each material in Tables 1 to 5 are parts by weight (where the values in parentheses for the conductive powder A and silver powder are the volume ratios (units: vol %) of the conductive powder A or silver powder based on the total volume of the conductive powder A or silver powder and the binder component).

YL-980: Bisphenol A-type epoxy resin, product of Yuka-Shell Epoxy Co. Ltd.;

EX-212: Neopentylglycol-type epoxy resin, product of Nagase Chemicals, Ltd.;

2PHZ: Imidazole compound with a hydroxyl group 2-phenyl-4,5-hydroxymethylimidazole, product of Shikoku Chemicals Corp.;

2PZ-CNS: Imidazole compound with a carboxyl group 1-cyanoethyl-2-phenylimidazolium trimellitate, product of Shikoku Chemicals Corp.;

C11Z-CNS: Imidazole compound with a carboxyl group 1-cyanoethyl-2-undecylimidazolium trimellitate, product of Shikoku Chemicals Corp.;

C17Z: Imidazole compound without a hydroxyl group and carboxyl group 2-undecylimidazole, product of Shikoku Chemicals Corp.;

2MZA: Imidazole compound without a hydroxyl group and carboxyl group 2,4-diamino-6-(2′-methylimidazolyl-(1′))-ethyl-s-triazine, product of Shikoku Chemicals Corp.;

1B2PZ: Imidazole compound without a hydroxyl group and carboxyl group 1-benzyl-2-phenylimidazole, product of Shikoku Chemicals Corp.;

Silver powder (TCG-1): trade name of Tokuriki Chemical Research Co., Ltd.

### Evaluation of Volume Resistivity, Adhesive Strength And Migration Resistance

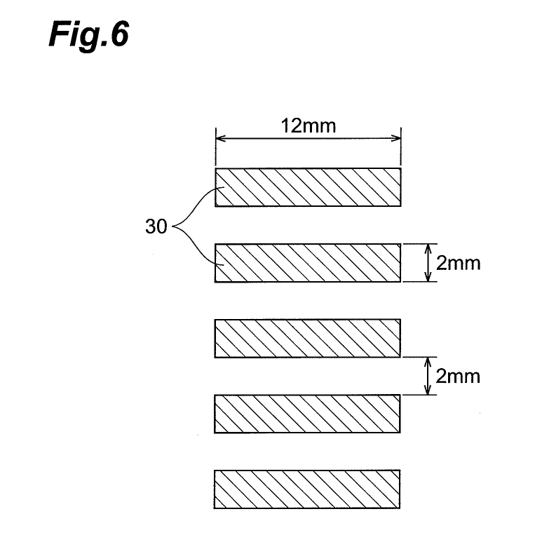

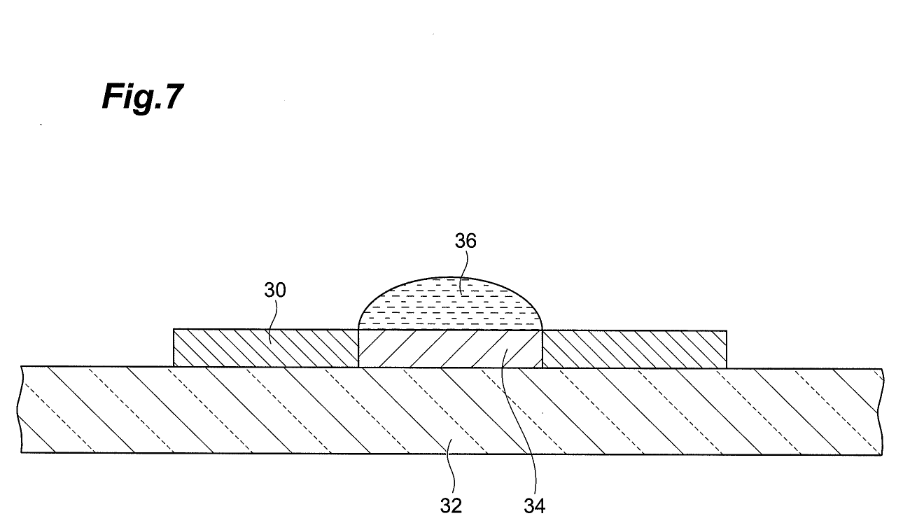

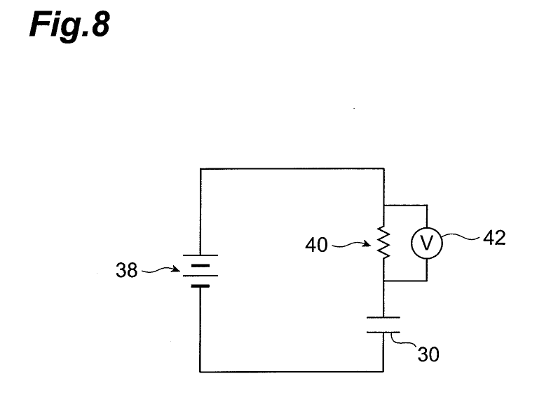

The properties of the conductive pastes of Examples 1 to 16, Comparative Examples 1 to 5 and Reference Examples 1 to 8 were measured by the following methods. The results are shown together in Tables 1 to 5.
(1) Volume resistivity: The conductive paste molded to 1×50×0.03 mm was heated to 180° C. at a temperature-elevating rate of 4° C./min with an oxygen concentration of 1000 ppm, and then heated at 180° C. for one hour to produce a test piece for measurement of the volume resistivity by the four-terminal method.
(2) Adhesive strength (adhesive force): The conductive paste was coated at approximately 0.5 mg on an Sn-plated copper sheet, and a 2×2×0.25 mm Ag-plated copper chip was contact bonded thereover and adhered by heat curing by the heating process of (1) above. The shear strength was measured at 25° C. using a bond tester (2400 by DAGE) at a shear speed of 500 μm/sec and a clearance of 100 μm.
(3) Migration resistance: The conductive paste was printed on a glass panel by screen printing using a 100 μm-thick metal mask, and the temperature was raised to 180° C. at a temperature-elevating rate of 4° C./min with an oxygen concentration of 1000 ppm, after which heat treatment was carried out at 180° C. for one hour for curing to fabricate electrodes 30 (12 mm×2 mm, inter-electrode distance: 2 mm) shown in FIG. 6. Next, as shown in FIG. 7, filter paper 34 was situated between the electrodes 30 formed on the glass panel 32, and ion-exchanged water 36 was dropped onto the filter paper 34 (No. 5A). Next, as shown in FIG. 8, 10 V was applied to a circuit comprising the electrodes 30, a power source 38, a resistor 40 and a recorder 42 in connection, and the time until the leakage current between the electrodes after voltage application varied 10% with respect to the initial value (immediately after voltage application) was measured. In order to maintain the ion-exchanged water 36 in a constant form, filter paper 34 was situated between the electrodes 30 and ion-exchanged water 36 was filled every 10 minutes to prevent drying. A longer leakage current variation time (min) measured in this manner indicates more excellent migration resistance.

TABLE 1

| | | Examples | | | | | | | |
|---|---|---|---|---|---|---|---|---|---|
| | | 1 | 2 | 3 | 4 | 5 | 6 | 7 | 8 |
| Epoxy resin | YDF-170 | 70 | — | 70 | 70 | 73.9 | 66.1 | 70 | 70 |
| | YL-980 | — | 70 | — | — | — | — | — | — |
| | PP-101 | 20 | 20 | — | 20 | 21.1 | 18.9 | 20 | 20 |
| | EX-212 | — | — | 20 | — | — | — | — | — |
| Imidazole | 2P4 MHZ | 10 | 10 | 10 | — | 3 | 15 | 10 | 10 |
| compound | 2P HZ | — | — | — | 10 | — | — | — | — |
| with OH | | | | | | | | | |

| | | | | | | | | |
|---|---|---|---|---|---|---|---|---|
| Conductive powder A | 330 (30) | 330 (30) | 330 (30) | 330 (30) | 330 (30) | 330 (30) | 257 (25) | 770 (50) |
| (vol %) | | | | | | | | |
| Volume resistivity | 7.5 | 9.0 | 5.4 | 11.3 | 4.9 | 11.2 | 15.8 | 2.2 |
| (×10⁻⁴ Ω/cm) | | | | | | | | |
| Adhesive strength | 258 | 241 | 250 | 266 | 225 | 192 | 263 | 155 |
| (N/chip) | | | | | | | | |
| Leakage current | 48 | 51 | 55 | 50 | 63 | 41 | 61 | 38 |
| variation time (min) | | | | | | | | |

TABLE 2

| | | Examples | | | | | | | |
|---|---|---|---|---|---|---|---|---|---|
| | | 9 | 10 | 11 | 12 | 13 | 14 | 15 | 16 |
| Epoxy resin | YDF-170 | 70 | — | 70 | 70 | 73.9 | 66.1 | 70 | 70 |
| | YL-980 | — | 70 | — | — | — | — | — | — |
| | PP-101 | 20 | 20 | — | 20 | 21.1 | 18.9 | 20 | 20 |
| | EX-212 | — | — | 20 | — | — | — | — | — |
| Imidazole | 2PZ-CNS | 10 | 10 | 10 | — | 3 | 15 | 10 | 10 |
| compound | C11Z- | — | — | — | 10 | — | — | — | — |
| with COOH | CNS | | | | | | | | |

| | | | | | | | | |
|---|---|---|---|---|---|---|---|---|
| Conductive powder A | 330 (30) | 330 (30) | 330 (30) | 330 (30) | 330 (30) | 330 (30) | 257 (25) | 770 (50) |
| (vol %) | | | | | | | | |
| Volume resistivity | 11.3 | 12.6 | 9.2 | 16.4 | 7.4 | 17.9 | 21.5 | 3.7 |
| (×10⁻⁴ Ω/cm) | | | | | | | | |
| Adhesive strength | 283 | 273 | 289 | 295 | 240 | 211 | 278 | 194 |
| (N/chip) | | | | | | | | |
| Leakage current | 55 | 45 | 41 | 52 | 66 | 38 | 60 | 32 |
| variation time (min) | | | | | | | | |

TABLE 3

| | | Comparative Examples | | | | |
|---|---|---|---|---|---|---|
| | | 1 | 2 | 3 | 4 | 5 |
| Epoxy resin | YDF-170 | 70 | 70 | 70 | 70 | 70 |
| | PP-101 | 20 | 20 | 20 | 20 | 20 |
| Imidazole | C17Z | 10 | — | — | — | — |
| compound | 2MZA | — | 10 | — | — | — |
| without OH and | 1B2PZ | — | — | 10 | — | — |
| COOH | | | | | | |
| Imidazole | 2P4 MHZ | — | — | — | 10 | — |
| compound with | | | | | | |
| OH | | | | | | |
| Imidazole | 2PZ-CNS | — | — | — | — | 10 |
| compound with | | | | | | |
| COOH | | | | | | |

| | | | | | |
|---|---|---|---|---|---|
| Conductive powder A (vol %) | 330 (30) | 330 (30) | 330 (30) | — | — |
| Silver powder (TCG-1) (vol %) | — | — | — | 375 (30) | 375 (30) |
| Volume resistivity | 117 | >10000 | >10000 | 1.5 | 2.1 |
| (×10⁻⁴ Ω/cm) | | | | | |
| Adhesive strength (N/chip) | 181 | 311 | 272 | 275 | 281 |
| Leakage current variation | 45 | 48 | 52 | 1.5 | 1.0 |
| time (min) | | | | | |

TABLE 4

| | | Reference Example | | | |
|---|---|---|---|---|---|
| | | 1 | 2 | 3 | 4 |
| Epoxy resin | YDF-170 | 76.2 | 62.2 | 70 | 70 |
| | PP-101 | 21.8 | 17.8 | 20 | 20 |
| Imidazole | 2P4 MHZ | 1 | 20 | 10 | 10 |
| compound | | | | | |
| with OH | | | | | |

| | | | | |
|---|---|---|---|---|
| Conductive powder A | 330 (30) | 330 (30) | 136 (15) | 1431 (65) |
| (vol %) | | | | |
| Volume resistivity | 53.5 | 74.8 | >10000 | 1.1 |
| (×10⁻⁴ Ω/cm) | | | | |
| Adhesive strength | 129 | 107 | 216 | 96 |
| (N/chip) | | | | |
| Leakage current variation | 43 | 35 | 66 | 32 |
| time (min) | | | | |

TABLE 5

| | | Reference Example | | | |
|---|---|---|---|---|---|
| | | 5 | 6 | 7 | 8 |
| Epoxy resin | YDF-170 | 76.2 | 62.2 | 70 | 70 |
| | PP-101 | 21.8 | 17.8 | 20 | 20 |
| Imidazole | 2PZ-CNS | 1 | 20 | 10 | 10 |
| compound | | | | | |
| with COOH | | | | | |

| | | | | |
|---|---|---|---|---|
| Conductive powder A | 330 (30) | 330 (30) | 136 (15) | 1431 (65) |
| (vol %) | | | | |
| Volume resistivity | 109 | 81.5 | >10000 | 2.4 |
| (×10⁻⁴ Ω/cm) | | | | |
| Adhesive strength | 134 | 121 | 244 | 7 |
| (N/chip) | | | | |
| Leakage current variation | 50 | 33 | 72 | 28 |
| time (min) | | | | |

### Conductive Member Fabrication Examples 1 To 10 And Their Evaluation

The properties of conductive members (cured conductive pastes) for Fabrication Examples 1 to 10 produced in the following manner were measured by the methods described below. The results are shown in Table 4.
(1) Volume resistivity: The conductive paste of Example 1 shaped to 1×50×0.03 mm was heated to 180° C. at the temperature-elevating rates and oxygen concentrations listed in Table 6 (Fabrication Examples 1 to 5), and then heated at 180° C. for one hour to produce test pieces for measurement of the volume resistivity by the four-terminal method. The conductive paste of Example 9 shaped to 1×50×0.03 mm was heated to 180° C. at the temperature-elevating rates and oxygen concentrations listed in Table 7 (Fabrication Examples 6 to 10), and then heated at 180° C. for one hour to produce test pieces for measurement of the volume resistivity by the four-terminal method.
(2) Adhesive strength (adhesive force): The conductive paste of Example 1 was coated at approximately 0.5 mg on an Sn-plated copper sheet, and a 2×2×0.25 mm Ag-plated copper chip was contact bonded thereover and adhered by increasing the temperature to 180° C. at the oxygen concentrations and temperature-elevating rates listed in Table 6 (Fabrication Examples 1 to 5) and then conducting heat treatment at 180° C. for one hour. The shear strength was measured at 25° C. using a bond tester (2400 by DAGE) at a shear speed of 500 μm/sec and a clearance of 100 μm. The conductive paste of Example 9 was coated at approximately 0.5 mg on an Sn-plated copper sheet, and a 2×2×0.25 mm Ag-plated copper chip was contact bonded thereover and adhered by increasing the temperature to 180° C. at the oxygen concentrations and temperature-elevating rates listed in Table 7 (Fabrication Examples 6 to 10) and then conducting heat treatment at 180° C. for one hour. The shear strength was measured at 25° C. using a bond tester (2400 by DAGE) at a shear speed of 500 μm/sec and a clearance of 100 μm.

TABLE 6

| | Fabrication Example | | | | |
|---|---|---|---|---|---|
| | 1 | 2 | 3 | 4 | 5 |
| Temperature-elevating rate | 5 | 5 | 15 | 25 | 5 |
| (° C./min) | | | | | |
| Oxygen concentration (ppm) | 100 | 10000 | 100 | 100 | 100000 |
| Volume resistivity | 7.5 | 7.8 | 8.1 | 5.3 | 169 |
| (×10⁻⁴ Ω/cm) | | | | | |
| Adhesive strength (N/chip) | 258 | 260 | 210 | 142 | 247 |

TABLE 7

| | Fabrication Example | | | | |
|---|---|---|---|---|---|
| | 6 | 7 | 8 | 9 | 10 |
| Temperature-elevating rate | 5 | 5 | 15 | 25 | 5 |
| (° C./min) | | | | | |
| Oxygen concentration (ppm) | 100 | 10000 | 100 | 100 | 100000 |
| Volume resistivity | 11.3 | 24.5 | 46.8 | 8.8 | 264 |
| (×10⁻⁴ Ω/cm) | | | | | |
| Adhesive strength (N/chip) | 283 | 278 | 286 | 115 | 270 |

As understood by the foregoing explanation of the present invention, the conductive paste of the invention can achieve improved conductivity while maintaining prescribed adhesive strength. Thus, when a conductive paste according to the invention is used as a conductive adhesive for surface mounting of electronic parts, it is possible to achieve satisfactory conductivity with a lower conductive particle content than with the conventional art. The conductive paste of the invention can also provide a good balance between conductivity and adhesive strength with a lower conductive particle content than the conventional art, in order to achieve increased product reliability. The conductive paste of the invention can also adequately inhibit migration.

As clearly shown by the results in Tables 6 and 7, by limiting the temperature-elevating rate to 2 to 20° C./min and the oxygen concentration to 20 to 50000 ppm in a thermosetting process in which a conductive paste of the invention is heat cured, it is possible to achieve particularly excellent conductivity and adhesive strength for the cured conductive members (Fabrication Examples 1 to 3). Consequently, by using a conductive paste of the invention in a thermosetting process under the conditions described above for fabrication of an electronic part mounting board, it is possible to obtain an electronic part mounting board with satisfactory conductivity.

### INDUSTRIAL APPLICABILITY

As explained above, according to the invention there is provided a conductive paste that maintains a prescribed adhesive strength while exhibiting excellent conductivity and migration resistance. Moreover, by using a conductive paste of the invention it is possible to provide an electronic part mounting board with satisfactory conductivity.

1. A conductive paste containing conductive powder and a binder component,
wherein the conductive powder is composed of metal powder which is copper powder or copper alloy powder partially covered on the surface with silver, and is either a mixture of roughly spherical metal powder and flat metal powder, or roughly spherical or flat metal powder alone, and
the binder component contains a mixture of an epoxy resin and a imidazole compound with a hydroxyl group.

2. A conductive paste according to claim 1,
wherein the mixing ratio of the conductive powder and binder component is 20:80 to 60:40 in terms of volume ratio.

3. A conductive paste according to claim 2,
wherein the mixing proportion of the imidazole compound is 2 to 18 wt % based on the total binder component.

4. A conductive paste according to claim 3,
wherein the imidazole compound is 2-phenyl-4,5-dihydroxymethylimidazole or 2-phenyl-4-methyl-5-hydroxymethylimidazole.

5. A conductive paste according to claim 1,
wherein the mixing proportion of the imidazole compound is 2 to 18 wt % based on the total binder component.

6. A conductive paste according to claim 5,
wherein the imidazole compound is 2-phenyl-4,5-dihydroxymethylimidazole or 2-phenyl-4-methyl-5-hydroxymethylimidazole.

7. A conductive paste according to claim 1,
wherein the imidazole compound is 2-phenyl-4,5-dihydroxymethylimidazole or 2-phenyl-4-methyl-5-hydroxymethylimidazole.

8. A conductive paste containing conductive powder and a binder component,
wherein the conductive powder is composed of metal powder which is copper powder or copper alloy powder partially covered on the surface with silver, and is either a mixture of roughly spherical metal powder and flat metal powder, or roughly spherical or flat metal powder alone, and
the binder component contains a mixture of an epoxy resin and an imidazole compound with a carboxyl group.

9. A conductive paste according to claim 8,
wherein the mixing ratio of the conductive powder and binder component is 20:80 to 60:40 in terms of volume ratio.

10. A conductive paste according to claim 9,
wherein the mixing proportion of the imidazole compound is 2 to 18 wt % based on the total binder component.

11. A conductive paste according to claim 10,
wherein the imidazole compound is 1-cyanoethyl-2-phenylimidazolium trimellitate, 1-cyanoethyl-2-undecylimidazolium trimellitate, 1-cyanoethyl-2-methylimidazolium trimellitate, 1-cyanoethyl-2-ethyl-4-methylimidazolium trimellitate or 1-benzyl-2-phenyl imidazolium trimellitate.

12. A conductive paste according to claim 8,
wherein the mixing proportion of the imidazole compound is 2 to 18 wt % based on the total binder component.

13. A conductive paste according to claim 12,
wherein the imidazole compound is 1-cyanoethyl-2-phenylimidazolium trimellitate, 1-cyanoethyl-2-undecylimidazolium trimellitate, 1-cyanoethyl-2-methylimidazolium trimellitate, 1-cyanoethyl-2-ethyl-4-methylimidazolium trimellitate or 1-benzyl-2-phenyl imidazolium trimellitate.

14. A conductive paste according to claim 8,
wherein the imidazole compound is 1-cyanoethyl-2-phenylimidazolium trimellitate, 1-cyanoethyl-2-undecylimidazolium trimellitate, 1-cyanoethyl-2-methylimidazolium trimellitate, 1-cyanoethyl-2-ethyl-4-methylimidazolium trimellitate or 1-benzyl-2-phenyl imidazolium trimellitate.

15. An electronic part mounting board having a structure comprising a board and electronic part connected by a conductive member,
wherein the conductive member is obtained by curing a conductive paste according to by a thermosetting process in which the temperature-elevating rate is 2 to 20° C./min until reaching the maximum temperature and the oxygen concentration is 20 to 50000 ppm.

16. An electronic part mounting board having a structure comprising a board and electronic part connected by a conductive member,
wherein the conductive member is obtained by curing a conductive paste according to claim 8 by a thermosetting process in which the temperature-elevating rate is 2 to 20° C./min until reaching the maximum temperature and the oxygen concentration is 20 to 50000 ppm.
